(19) United States
(12) Patent Application Publication
(10) Pub. No.: US 2005/0120238 A1
(43) Pub. Date: Jun. 2, 2005

(54) Virus protection method and computer-readable storage medium containing program performing the virus protection method

(76) Inventor: Won Hyok Choi, Seoul (KR)

Correspondence Address: Global Hauri, Inc.;Attn: Esther J. Shon, Controller, iPark No. 234, 3003 North First Street, San Jose, CA, 95134, US

(21) Appl. No.: 10/831,601

(22) Filed: Apr. 23, 2004

(30) Foreign Application Priority Data
Dec. 2, 2003 (KR) 10-2003-0086618

(51) Int. Cl. H04L 9/32

(52) U.S. Cl. 713/200

(57) ABSTRACT

A method for securing a computer system against virus includes purifying processes residing in a random access memory (RAM), purifying at least a file associated with the process, the file being stored in a hard disk, and purifying threads dependent on each process residing in the RAM.

### FIELD OF THE INVENTION

The present invention relates to a technique and computer-readable storage medium for securing a computer system against viruses. More specifically, the invention relates to a virus protection method for scanning processes, threads and files associated with the processes so as to reliably prevent the processes and threads dependent on files from being infected; and disinfecting the infected processes, threads, and files.

### BACKGROUND OF THE RELATED ART

While a program file is executed in a computer system, process corresponding to the program resides in a memory. When viruses infect the processes residing in a memory and/or files stored in a storage medium (such as a hard disk) the viruses are exponentially spread to other processes and files.

Typically, computer anti-virus software first searches a list of the processes stored in the memory and then scans the files corresponding to the processes, stored in the storage medium. If an infected file is detected during the scanning, the anti-virus software kills the process corresponding to the virus infected file, disinfects the file stored in the hard disk, and then executes the file in order for the normal process to reside in the memory again.

However, this anti-virus software cannot scan and disinfect the computer viruses that have recently appeared that infect only the processes or threads dependent on the processes but not the actual files.

That is, since the conventional anti-virus software just refers to the files for scanning and kills the process corresponding to the file infected, it is impossible to scan and disinfect the process or thread infectious viruses.

### SUMMARY OF THE INVENTION

Accordingly, the present invention is directed to a virus protection method that substantially obviates one or more problems due to limitations and disadvantages of the related art.

It is an object of the present invention to provide a computer virus protection method capable of scanning processes and threads residing in the memory as well as the files corresponding to processes and reliably disinfecting the infected processes and threads using information in memory areas likely to be infected.

It is another object of the present invention to provide a computer-readable storage medium containing a virus protection program which is capable of scanning processes and threads residing in the memory as well as the files corresponding to processes and reliably disinfecting the infected processes and threads using information in memory areas likely to be infected.

To achieve the above objects, the computer virus protection method according to a preferred embodiment of the present invention comprises purifying active entities executed in a volatile storage and purifying at least one passive entity associated with the active entities, the passive entity being stored in a non-volatile storage. The active entities are processes and the passive entity is a file associated with the process. The volatile storage is a random access memory (RAM) and the non-volatile storage may include a hard disk and/or a floppy disk (though other non-volatile storage media may be used in other embodiments). The step of purifying active entities includes scanning the active entities to determine whether or not each active entity is infected by a virus and restoring the active entity if the active entity is infected. The virus infection scanning step includes searching an entry point of the active entity residing in the volatile storage and checking whether or not a virus-specific pattern exists at a predetermined position, which may be the entry point. The active entity restoring step includes disinfecting the active entity and terminating the active entity if it is impossible to disinfect the active entity. The passive entity purifying step includes scanning whether or not the passive entity is infected by a virus and restoring the passive entity if the file is infected. The passive entity scanning step includes searching the passive entity corresponding to the process from the non-volatile storage and checking whether or not a virus-specific pattern exists at a predetermined position. The computer virus protection method further includes re-executing the passive entity.

In another aspect of the present invention, the computer virus protection method comprises purifying processes residing in a random access memory (RAM) and purifying at least one file associated with the processes, the file being stored in a hard disk. The processes purification step includes scanning whether or not each process is infected by a virus and restoring the process to an uninfected state if the process is infected. The virus infection scanning step includes searching a start point of the process residing in the RAM and checking whether or not a virus specific pattern exists at a predetermined position, which may be the entry point. The process restoring step includes disinfecting the process and terminating the process if it is impossible to disinfect the process. The file purifying step includes scanning whether or not the file is infected by a virus and restoring the file if the file is infected. The file scanning step includes searching the file corresponding to the process from the hard disk and checking whether or not a virus specific pattern exists at a predetermined position. The computer virus protection method further includes re-executing the file.

In another aspect of the present invention, the computer virus protection method further comprises purifying threads residing in the RAM. The threads purifying step includes scanning whether or not each thread is infected by the virus and terminating the thread if the thread is infected. The virus infection scanning step on the thread includes searching a start point of the thread residing in the RAM and checking whether or not a virus specific pattern exists at a predetermined position, which may be the start point.

In another aspect of the present invention, the computer-readable storage medium contains a computer program for performing a virus protection method which comprises purifying processes residing in a random access memory (RAM) and purifying at least one file associated with the processes, the file being stored in a hard disk. The processes purifying step includes scanning whether or not each process is infected by a virus and restoring the process if the process is infected. The virus infection scanning step includes searching a start point of the process residing in the RAM and checking whether or not a virus specific pattern exists at a predetermined position, which may be the start point. The process-restoring step includes disinfecting the process and terminating the process if it is impossible to disinfect the process. The file purifying step includes scanning whether or not the file is infected by a virus and restoring the file if the file is infected. The file scanning step includes searching the file corresponding to the process from the hard disk and checking whether or not a virus specific pattern exists at a predetermined position. The program further includes re-executing the file.

In another aspect of the present invention, the computer-readable storage medium containing a computer program performs a virus protection method which further includes purifying threads residing in the RAM. The threads purifying step includes scanning to determine whether or not each thread is infected by the virus and terminating the thread if the thread is infected. The virus infection scanning step on the thread includes searching a start point of the thread residing in the RAM and checking whether or not a virus specific pattern exists at a predetermined position.

### BRIEF DESCRIPTION OF THE DRAWINGS

FIG. 1 is a conceptual view illustrating how the infected process is disinfected by a virus protection method according to the preferred embodiment of the present invention.

FIG. 2 is a conceptual view illustrating how to scan/purify the virus resident at the thread region according to the preferred embodiment of the present invention.

FIG. 3 is a flowchart illustrating the steps of the virus protection method according to the preferred embodiment of the present invention.

FIG. 4 is a flowchart illustrating the steps of a virus protection method according to another preferred embodiment of the present invention.

FIG. 5 is a flowchart illustrating the steps of a virus protection method according to another preferred embodiment of the present invention.

### DETAILED DESCRIPTION OF THE PREFERRED EMBODIMENT

In the following detailed description, only the preferred embodiment of the present invention has been shown and described, simply by way of illustration of the best mode contemplated by the inventor(s) of carrying out the invention. As will be realized, the present invention is capable of modification in various respects, all without departing from the invention. Accordingly, the drawings and description are to be regarded as illustrative in nature, and not restrictive.

The virus protection method according to the preferred embodiment of the present invention will be described with an exemplary computer system running the Windows operating system. While the present invention will be described in connection with this operating system, it is to be understood that the present invention is not limited to one specific operating system. It should be clearly understood that other operating systems could use the basic inventive concept taught herein which may appear to those skilled in the art and will fall within the spirit and scope of the present invention.

Definition of Terms

Virus susceptible area: Typically, the area susceptible to virus, such as memories, files, services, registry, TCP/IP packet ports, boot sectors.

Operating System (OS): The software which handles the interface to peripheral hardware, schedules tasks, allocates storage, and presents a default interface to the user. Such an operating system includes MS-DOS Macintosh Windows OS/2 Unix Linux etc.

Function to be used to scan information about virus susceptible areas: The functions provided by the operating system such as API, system calls, etc.

Application Program Interface (API): The interface by which an application program accesses operating system and other services.

System Call: The invocation of an operating system routine. Operating systems contain sets of routines for performing various operations. For example, all operating systems have a routine for creating a directory.

Process kill: This means terminating an active process, i.e., removing the process from a memory.

Among the computer viruses, some such as CodeRed and Slamer infect only process regions of the memory but not files. In order to disinfect the processes infected by these viruses, it is first required to scan the process regions of the memory.

FIG. 1 is a conceptual view illustrating how the infected process is disinfected by a virus protection method according to the preferred embodiment of the present invention. Reference numeral 1 denotes a memory, reference numeral 2 denotes a process list, reference numeral 3 designates process regions which are mapped to the processes in the process list, and the reference numeral 4 represents a storage device.

As shown in FIG. 1, the virus protection method searches the process list 2 and entry point (EP) of each process, and scans whether or not the process is infected at step (a). If the process B is infected and the process B is damaged so as not to be restored, the virus protection method kills the process B at step (b). At this time, the virus protection method preferably shows this procedure status using a dialogue box before killing the process B. After killing the process B, the virus protection method searches a file B corresponding to the process B in the storage device 4.

After scanning and disinfecting the file B, the virus protection method re-executes the process B at step (c) such that the disinfected process B resides on the memory at step (d).

At step (c), even though the process B can be terminated without being re-executed, it is preferable that the process B corresponding to the file B is executed again.

The virus protection method according to the present invention utilizes an Application Program Interface (API) function for searching information on the virus susceptible region.

The virus protection method scans and disinfects the processes searched in the memory. Additionally, if it is required to scan and disinfect the thread regions, it is possible to scan and disinfect the thread regions using the API function.

First, the virus protection method searches the list of processes residing in the memory and the entry point (EP) of each process using the API function such as NTDLL.DLL::NtQuerySysteminformation, NTDLL.DLL::LdrGetDllHandle, or the like.

Next, the virus protection method scans whether or not the process is infected by the virus. The process scan procedure of the virus protection method is as follows.

The virus changes the code of the target file so as to first execute itself. The virus has the original code in its own executable code. If the virus does not have the original code, a system error occurs. Accordingly, the virus is likely to have the original code in order for the system to normally execute the file.

Accordingly, it is possible to obtain information needed for the virus scan and disinfection by analyzing the virus infection pattern.

In this manner, the virus protection method has the information such as the virus specific pattern, the code location changeable by the virus infection, and the original code location required for code restoration, and code length.

The virus protection method scans the process by checking whether or not the virus specific pattern is located at a predetermined position from the entry point of the process. If the virus specific pattern is located at that position, the virus protection method determines whether or not the process can be disinfected.

In case the original code exists in the virus it is possible to disinfect the process. The virus protection method disinfects the infected process using the information. At this time, since the corresponding memory region may be set to read-only, it is preferable to perform disinfection procedure after releasing the read-only setting so as to be writable thereon.

When the virus does not have the original code therein (and the program can not disinfect the infected process), the virus protection method kills the process residing in the memory. For example, among the processes A, B, and C residing in the memory, if the process B is infected by the virus and it is impossible to disinfect the infected process B, the virus protection method kills the process B. This is illustrated in (c) of FIG. 1.

Prior to killing the memory resident process B, the virus protection method preferably notifies the user of killing the process B. The reason why the notification message is displayed is to prevent the job presently being rendered by the process B from being interrupted and to allow the user to store work.

Accordingly, the process B is killed after the user selects a confirmation message.

After killing the process, the virus protection method searches the file corresponding to the process from the storage (for example, hard disk), i.e., the file B corresponding to the process B as shown in FIG. 1.

If the target file does not exist in the storage, the virus protection method is terminated.

If the file corresponding to the process is searched in the storage, the virus protection method scans and disinfects the file. Then, if required or preferred, the virus protection method further performs virus scan on the thread regions. This procedure will be described later.

When the process which cannot be disinfected is terminated in the memory, it is preferred to re-execute the corresponding file after the file is scanned and disinfected. In FIG. 1, if the file B is re-executed, the purified process B loaded in the memory such that the virus is completely disinfected. Here, the reason why the process B is re-executed in the memory is because the operating system does not work normally if the process is the one utilized by the operating system and is killed during the disinfection procedure.

The process infected by the virus is already killed such that the associated file stored in the storage device can be maintained without infection.

Meanwhile, there are threads regions in the memory. The viruses (for example, Elkern virus) attacking the threads adds the virus-infected thread in the thread regions of the process.

Accordingly, it is possible to remove the virus without affecting the presently-working process by killing the infected thread.

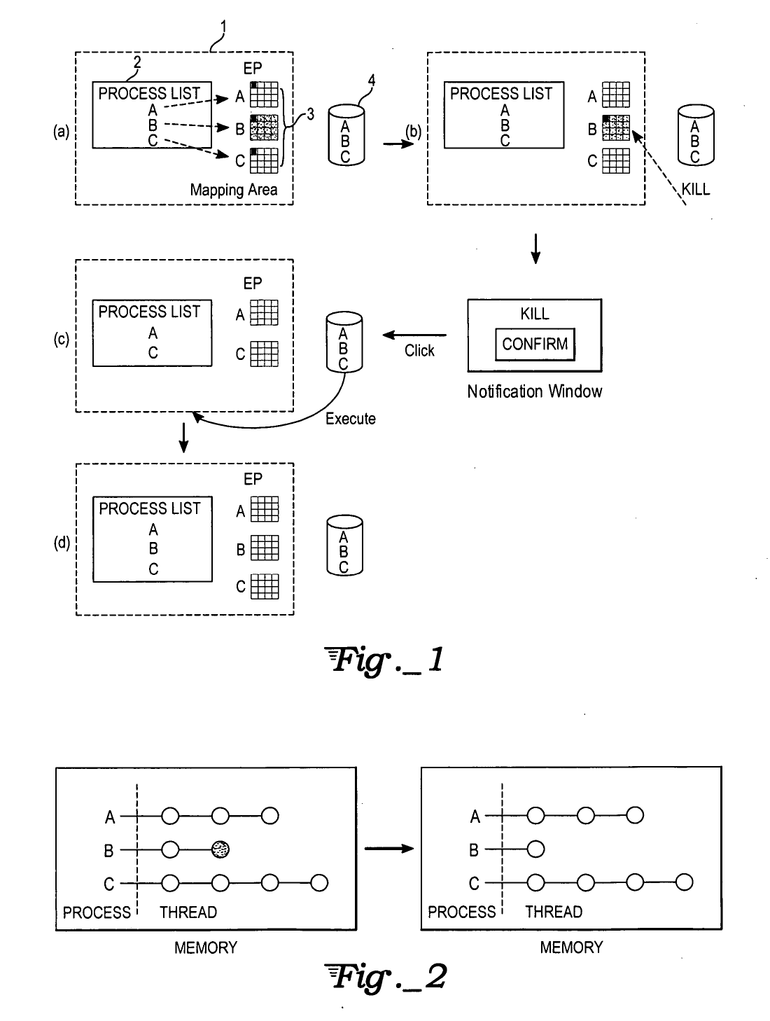

FIG. 2 is a conceptual view illustrating how to scan/purify the virus resident at the thread region according to the preferred embodiment of the present invention. In order to scan and purify the virus from the thread region, firstly, the virus protection method searches a thread list of each process and the entry point (EP) of each thread.

In the same manner as the process search procedure, the virus protection method detects the thread list and entry points of the threads using the API function (for example, NTDLL.DLL::NtResumeThread).

Next, the virus protection method scans whether or not the thread is infected by the virus. That is, the virus protection method determines whether or not the thread is infected by checking the virus specific pattern at the predetermined position from the entry point.

After the scan, if it is determined that the thread is infected, the virus protection method kills the infected thread such that it is possible to remove the virus without killing the presently working process.

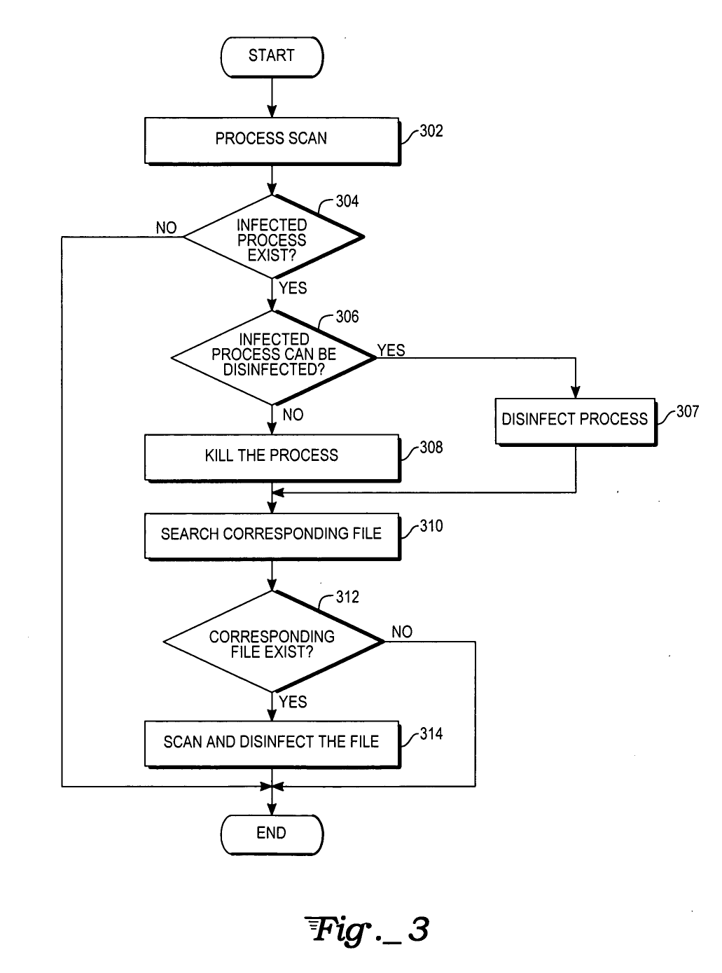

The virus protection method according to the preferred embodiment of the present invention will be described hereinafter with reference to FIG. 3 to FIG. 5. Only the preferred embodiments of the present invention have been shown and described, simply by way of illustration of the best mode contemplated by the inventor for carrying out the invention. The invention is capable of modification in various respects, all without departing from the invention.

FIG. 3 is a flowchart for illustrating the virus protection method according to one embodiment of the present invention.

As shown in FIG. 3, first the virus protection method searches the list of process resident on the memory and entry point of each process and then scans whether or not the process is infected by a virus at step 302.

If the process is infected at step 304, the virus protection method determines whether or not the infected process can be disinfected at step 306.

If it is determined that the infected process can be disinfected, the virus protection method disinfects the process at step 307, and searches the file corresponding to the process at step 310.

On the other hand, if the infected process cannot be disinfected, the virus protection method kills the infected process at step 308 and then searches the corresponding file from the storage device at step 310.

Consequently, the virus protection method determines whether or not the corresponding file exists in the storage device at step 312.

When the corresponding file exists in the storage device, the virus protection method scans and disinfects, if it is infected, the file at step 314. The virus protection method preferably re-executes the corresponding file so as to reside the process which is terminated on the memory.

On the other hand, if the corresponding file does not exist in the storage device, the virus protection method just ends.

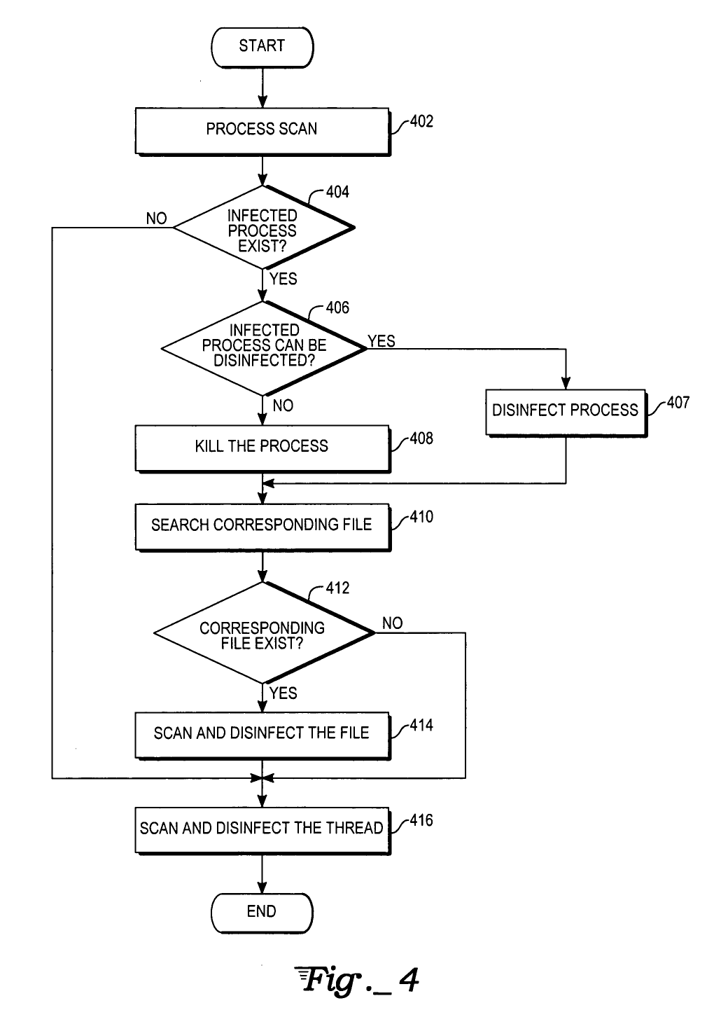

FIG. 4 is a flowchart for illustrating a virus protection method according to another preferred embodiment of the present invention.

As in FIG. 3, the method of FIG. 4 begins with a process scan 402. The method next determines if an infected process exists (block 404). If an infected process does exist, the method determines if the process can be disinfected at block 406. If it can, the process is disinfected (block 407); if not, the process is killed (block 408). After the steps of block 408 or 407 are complete, the method searches the corresponding file (block 410). This method first requires determining if a corresponding file exists (412). If yes, the file is scanned and disinfectd (block 414). If not, block 414 is skipped.

The virus protection method according to the second embodiment further includes the thread regions scan and purification step (block 416). In the second preferred embodiment of the present invention, the virus scan and purification step 416 is performed after the file scan and disinfection step if an infected process is identified at step 404 or after the process scan (402) if no infected process is identified in step 404.

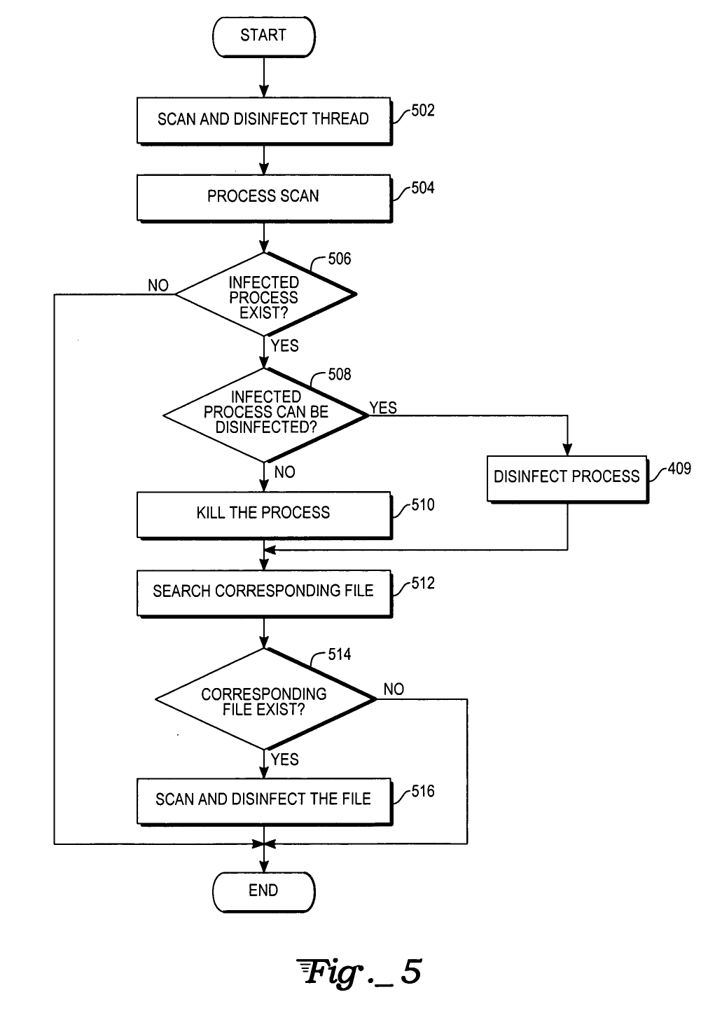

FIG. 5 is a flowchart for illustrating a virus protection method according to another preferred embodiment of the present invention. In the virus protection method according to the third preferred embodiment of the present invention, the thread regions scan and purification procedure is performed prior to the process scan and disinfection procedure.

That is, the virus protection method scans the processes resident on the memory at step 504 after scanning and purifying the thread regions of the memory at step 502. Then if any of the processes are infected by the virus at step 506, the virus protection method determines whether or not the infected process can be disinfected at step 508.

If it is determined, at step 508, that the virus-infected process can be disinfected, the virus protection method disinfects the infected process at step 509 and then searches the corresponding file in the storage device at step 512. On the other hand, if it is determined that the virus infected process cannot be disinfected, the virus protection method kills the virus infected process at step 510 and then searches the corresponding file in the storage device at step 512.

If the corresponding file exists in the storage device, the virus protection method scans the corresponding file and disinfects the file if it is infected (step 516).

On the other hand, if the corresponding file does not exist as determined at step 514 in the storage device, the virus protection method is terminated.

As described in the preferred embodiments with reference to FIG. 4 and FIG. 5, the thread region check and purification procedure can be performed before the process scan and disinfection procedure or after the file scan and disinfection procedure.

The above described virus protection method can be implemented as a computer readable program executed on the computer system. However, the virus protection method is not limited with the computer system but can be implemented as a program executable on a PDA, a mobile handset, a semiconductor device, or other industrial apparatus.

Also, the virus protection method can be stored in the storage medium as a computer-readable program and then can be executed by the computer system. The storage medium can be a magnetic storage medium (for example, a ROM, a floppy disk, a hard disk, etc.), an optical media (for example, CD-ROM, DVD-ROM, etc), and a carrier wave (for example, Internet transmission).

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

As described above, in the virus protection method according to the present invention, the regions susceptible to the virus, in particular, the processes and threads resident on the memory can be accurately examined so as to remove the viruses infecting the memory.

1. A method for securing a computer system against virus comprising:
purifying active entities residing in a volatile storage;
purifying at least one passive entity associated with the active entities, said passive entity being stored in a non-volatile storage.

2. A method of claim 1, wherein the active entities are processes.

3. A method of claim 2, wherein the passive entity is a file.

4. A method of claim 1, wherein the volatile storage is a random access memory (RAM).

5. A method of claim 1, wherein the non-volatile storage includes at least one of a hard disk or a floppy disk.

6. A method of claim 1, wherein purifying the active entities includes:
scanning to determine whether each active entity is infected by a virus; and
restoring the active entity to a noninfected state if the active entity is infected.

7. A method of claim 6, wherein scanning the virus infection includes:
searching an entry point of the active entity residing in the volatile storage; and
checking whether a virus-specific pattern exists at the entry point.

8. A method of claim 6, wherein restoring the active entity to a non-infected state includes:
(a) determining if the active entity can be disinfected while active;
(b) removing a virus from said active entity while active if step (a) determines such removal is possible; and
(c) terminating the active entity if it is impossible to disinfect the active entity as determined in step (a).

9. A method of claim 1, wherein purifying the passive entity includes:
scanning to determine whether the passive entity is infected by a virus; and
restoring the passive entity if the passive entity is infected.

10. A method of claim 9, wherein scanning the passive entity includes:
searching in the non-volatile storage the passive entity corresponding to the active entity; and
checking whether a virus-specific pattern exists at a predetermined position in the passive entity.

11. A method of claim 1 wherein the method further includes re-executing the passive entity after purifying active entities and purifying at least one passive entity steps are complete.

12. A method for securing a computer system against virus comprising:
purifying processes residing in a random access memory (RAM); and
purifying at least one file associated with the processes, the file being stored in a hard disk.

13. A method of claim 12, wherein purifying the processes includes:
scanning to determine whether each process is infected by a virus; and
restoring the process if the process is infected.

14. A method of claim 13, wherein scanning the virus infection includes:
searching a start point of the process residing in the RAM; and
checking whether a virus-specific pattern exists at a predetermined position.

15. A method of claim 13, wherein restoring the process to a non-infected state includes:
(a) determining if the process can be disinfected while active;
(b) removing a virus from said process while active if step (a) determines such removal is possible; and
(c) terminating the process if it is impossible to disinfect the process as determined in step (a).

16. A method of claim 12, wherein purifying the file includes:
scanning to determine whether the file is infected by a virus; and
restoring the file if the file is infected.

17. A method of claim 16, wherein scanning the file includes:
searching in the hard disk the file corresponding to the process; and
checking whether a virus-specific pattern exists at a predetermined position on the hard disk.

18. A method of claim 12, further including: re-executing the file after purifying processes residing in a RAM and purifying at least one file associated with the processes.

19. A method of claim 12 further including: purifying threads residing in the RAM.

20. A method of claim 19, wherein purifying threads includes:
scanning to determine whether each thread is infected by the virus; and
terminating the thread if the thread is infected.

21. A method of claim 20, wherein scanning the virus infection on the thread includes:
searching a start point of the thread resided in the RAM; and
checking whether a virus specific pattern exists at a predetermined position.

22. A computer-readable storage medium having instructions which, when read, cause a computer to perform a method for securing a computer system against virus comprising:
a means for purifying processes residing in a random access memory (RAM); and
a means for purifying at least a file associated with the processes, the file being stored in a hard disk.

23. A computer-readable storage medium of claim 22, wherein purifying the processes includes:
scanning to determine whether each process is infected by a virus; and
restoring the process if the process is infected.

24. A computer-readable storage medium of claim 23, wherein scanning the virus infection includes:
searching a start point of the process residing on the RAM; and
checking whether a virus specific pattern exists at a predetermined position.

25. A computer-readable storage medium of claim 23, wherein restoring the process includes:
disinfecting the process; and
terminating the process if it is impossible to disinfect the process.

26. A computer-readable storage medium of claim 22, wherein purifying the file includes:
scanning to determine whether the file is infected by a virus; and
restoring the file if the file is infected.

27. A computer-readable storage medium of claim 26, wherein scanning the file includes:
searching the file corresponding to the process from the hard disk; and
checking whether a virus-specific pattern exists at a predetermined position.

28. A computer-readable storage medium of claim 22, wherein the method further includes: re-executing the file.

29. A computer-readable storage medium of claim 22, wherein the method further includes:
purifying threads residing in the RAM.

30. A computer-readable storage medium of claim 29, wherein purifying threads includes:
scanning to determine whether each thread is infected by the virus; and
terminating the thread if the thread is infected.

31. A computer-readable storage medium of claim 30, wherein scanning the virus infection on the thread includes:
searching a start point of the thread residing on the RAM; and
checking whether a virus specific pattern exists at a predetermined position.

32. A computer-readable storage medium having instructions which, when read, cause a computer to perform a method for securing a computer system against virus comprising:
purifying processes residing in a random access memory (RAM); and
purifying at least one file associated with the processes, the file being stored in a hard disk.

33. A computer-readable storage medium of claim 32, wherein purifying the processes includes:
scanning to determine whether each process is infected by a virus; and
restoring the process if the process is infected.

34. A computer-readable storage medium of claim 33, wherein scanning the virus infection includes:
searching a start point of the process residing in the RAM; and
checking whether a virus specific pattern exists at a predetermined position.

35. A computer-readable storage medium of claim 33, wherein purifying the process includes:
(a) determining if the process can be disinfected while active;
(b) removing a virus from said process while active if step (a) determines such removal is possible; and
(c) terminating the process if it is impossible to disinfect the process as determined in step (a).

36. A computer-readable storage medium of claim 32, wherein purifying the file includes:
scanning to determine whether the file is infected by a virus; and
restoring the file if the file is infected.

37. A computer-readable storage medium of claim 36, wherein scanning the file includes:
searching in the hard disk the file corresponding to the process; and
checking whether a virus specific pattern exists at a predetermined position on the hard disk.

38. A computer-readable storage medium of claim 32, wherein the method further includes: re-executing the file after purifying processes residing in a RAM and purifying at least one file associated with the processes.

39. A computer-readable storage medium of claim 32 wherein the method further includes: purifying threads residing in the RAM.

40. A computer-readable storage medium of claim 39, wherein purifying threads includes:
scanning to determine whether each thread is infected by the virus; and
terminating the thread if the thread is infected.

41. A computer-readable storage medium of claim 40, wherein scanning the virus infection on the thread includes:
searching a start point of the thread residing in the RAM; and
checking whether a virus specific pattern exists at a predetermined position.
